(19) United States
(12) Patent Application Publication
(10) Pub. No.: US 2007/0114215 A1
(43) Pub. Date: May 24, 2007

(54) Method of pacing travel speed

(75) Inventor: Donald L. Bill, Parma, OH (US)

Correspondence Address: FAY SHARPE / LINCOLN, 1100 SUPERIOR AVENUE, SEVENTH FLOOR, CLEVELAND, OH, 44114, US

(73) Assignee: LINCOLN GLOBAL, INC.

(21) Appl. No.: 11/283,370

(22) Filed: Nov. 21, 2005

(51) Int. Cl. B23K 9/10

(52) U.S. Cl. 219/130.01; 219/137 R

(57) ABSTRACT

A method of pacing a desired travel speed of a manual arc welding process performed by a welder for depositing weld metal on a workpiece and along a test groove with a given test length defined by a visible start location and a visual end location using a specified amount of energy distributed generally uniformly in the groove between the locations. The method comprises providing a power source with output leads and an arc current and an arc voltage; setting the output welding power of the power source; providing a consumable welding wire; connecting the output leads across the welding wire and the workpiece; determining the time T for the wire to traverse the test length to consume the specific amount of energy; marking the groove with a visible indicia spaced from the start location a given distance; associating a programmable haptic device with an exposed body part of the welder where the device has a tactile alarm activated after a programmed time t from start of the haptic device, which time t is coordinated with the given distance to give the desired travel speed; starting the haptic device when the operator commences welding at the start location and employs a manual rate of travel; and, changing the manual rate of travel according to the relationship of the wire to the indicia when the tactile alarm is activated.

The present invention relates to the field of electric arc welding and more particularly to a method of pacing the travel speed of a welding operation used to form an assembly to test for physical properties.

### INCORPORATION BY REFERENCE

The invention relates to the construction of a standard weld test assembly using a haptic device of the tactile alarm type. Such devices are well known and are shown in several patents, such as Shahoian 6,697,044 incorporated by reference herein. The haptic device actually employed in practicing the invention is a wrist mounted tactile alarm watch having settable alarm times for vibrating the base of the device worn on the wrist. Such device is sold for use in announcing the time to take a medication. An undated two page stacking sheet shows this medication device referred to as MeDose. This publication is incorporated by reference herein to show the type of haptic device using a tactile alarm for implementation of the present invention.

### BACKGROUND

Many customers of welding wire, especially stick electrodes, require the testing of an assembly with fixed specification to determine physical characteristics of a weld produced by an electrode, such as a stick electrode or a welding wire used for semi-automatic welding. In testing each of these welding electrodes or wires, a standard procedure is performed by an operator. The welder prepares a test assembly with a weld joint formed by the electrode or wire to be analyzed. The weld must use a specific amount of input heat along the test joint. Creation of a weld test assembly requires uniform distribution of heat over a given length of the test weld. Precise specifications are often used by the military and have specific requirements. One of the critical requirements is a given amount of heat energy must be used in the weld per inch of length.

A representative example of the use of a welding procedure specification (WPS) is the American Welding Society specification AWS A5 5-96. This is for use of a cellulose stick electrode or several other stick electrodes. The WPS is number MA001. Incorporated by reference herein is a single sheet identifying the specifications for WPS MA001. This procedure is used for welding a test assembly to be subsequently tested for physical characteristics. To create the test assembly, the stick electrode being tested is used to fill the groove between spaced plates. The test groove has a given length, such as 12 inches. Filling by molten metal from the electrode must provide an even distribution of heat between the starting point and ending point of the groove. The weld metal joins the two spaced plates into a standard test assembly.

To assure that an even amount of heat is distributed along the groove during the welding process, the power source used for the welding operation is set to a selected power. The operator or welder moves the electrode being analyzed along the test groove at an even speed and then records the time necessary for traversing the set length of the test groove. The amount of heat per inch is then determined by multiplying the power by the lapsed time for the welding operation and then dividing this total consumed energy by the length of the groove. In this manner, the heat per inch of the assembly is determined. The critical specification for the standard test assembly produced by using the present invention is the heat used in the welding process. The welder starts the welding process by initiating the arc. As the arc is moved along the groove the electrode is melted and deposited in the groove. The expired time T must be a given value to assure distribution of the desired heat energy along the groove. This requirement presents practical difficulty. The welder has limited visibility through a welding helmet. Thus, the total weld time is the only variable when a fixed power is used for the welding process. To determine this variable, a timer is actuated by the power source as current flows at the start of the welding operation. The timer is stopped when the welding operation terminates at the end of the test groove. Time is recorded, but there is no way for the welder to pace the travel speed along the test groove. Consequently, the test assembly may be scrapped if the total welding time T is not close to the time necessary for inputting the specified amount of energy along the test groove. The present invention solves this problem by providing a method of pacing the travel speed of a manual arc welding process performed to produce the standard test assembly of the type required to meet a specification, such as WPS MA001. This specification demands that the test groove for joining the plates into a standard test assembly be filled with molten metal with a specified amount of heat per length along the test groove. This requires skill, practice and trial and error.

### THE INVENTION

The present invention paces the travel speed of the manual arc welding process performed by a welder as a weld metal is deposited on a workpiece along a test groove having a given test length. This test length is defined by the spacing between a visible start location marker and a visible end location marker. Such markers are now used to produce a test assembly. The procedure must consume a specific amount of energy distributed generally uniformly in the grooves and between the spaced locations. The travel speed used by the welder along the test groove determines the distribution of heat in the test groove. The novel method assists the welder in pacing the travel speed so the total welding time T is an amount to create the desired heat input along the groove. It is performed by providing a power source with output leads and an arc current and an arc voltage. The output power of the power source is fixed and the output leads are connected across the welding wire and the workpiece. In accordance with standard procedure, total time T for the wire to traverse the test length to consume the specific amount of energy for the groove is a known amount. The novelty of the invention is marking the groove with an indicia visible through the welding helmet and spaced from the start marker a given distance. This distance is usually halfway between the start location marker and the end location marker of the groove. A programmable haptic device is associated with an exposed body part of the welder. This device has a tactile alarm activated after a programmed time from the start of the haptic device. This programmed time is coordinated with the given distance of the added visible marker to indicate a desired speed to be paced by the welder. The haptic device is started when the operator commences welding at the start location marker. In accordance with the invention, the manual rate of travel by the welder is changed according to he relationship of the electrode to the added marker when the tactile alarm is activated.

In accordance with another aspect of the present invention, the given distance to the added marker is one-half the test length L between the start location marker and the end location marker. The tactile alarm is actuated at one-half the time T necessary for filling the test groove at the specified level of heat input.

In accordance with another aspect of the present invention, the haptic device is a device strapped onto the wrist of the welder. Preferably the wire being used to fill the test groove is a stick electrode.

Another aspect of the present invention is combining the novel aspects of the method as so far described with the standard process to measure total time T. Total time T is obtained by using a cycle timer that is started when the welding is at the start location. The timer is stopped when the welder stops welding at the end location. Both of these locations have visual markers and the timer is initiated automatically by current flow in the power source.

In accordance with another aspect of the present invention, the specific amount of energy along the test groove is in the range of 30-70 k Joules per inch. Furthermore, the metal forming the groove is preheated to a temperature in the general range of 100-250° F.

The primary object of the present invention is the provision of a method for producing a standard test assembly for subsequent physical testing of a welding procedure, which method utilizes a haptic device to assist in pacing the travel speed of the welding operation in the test groove used to join two plates into a standard test assembly meeting precise specifications.

Another object of the present invention is the provision of a method, as defined above, which method assures better pacing of the travel speed of the welding operation to produce a desired amount of heat input to the test groove of the test assembly and requiring less skill, less practice and less scrap.

These and other objects and advantages will become apparent from the following description taken together with the accompanying drawings.

### BRIEF DESCRIPTION OF DRAWINGS

FIG. 1 is a pictorial view of a standardized test assembly awaiting preparation for final welding by the method of the present invention;

FIG. 2 is a pictorial view of the hand of a welder depositing the weld metal on the test assembly shown in FIG. 1 by using a stick electrode for which the physical characteristics are to be analyzed;

FIG. 3 is a top view of the test assembly shown in FIG. 1 illustrating the welding process of the present invention;

FIG. 4 is a schematic timing diagram illustrating the location of the visual markers used in performing the pacing method of the present invention;

FIG. 5 is a simplified block diagram of the automatic timing system used in the prior art for making the standardized test assembly of FIG. 1 and also used in an aspect of the present invention;

FIG. 6 is a view similar to FIG. 4 illustrating a different spacing of the visual timing markers used in another embodiment of the present invention; and,

FIG. 7 is a view similar to FIGS. 4 and 6 illustrating the location of the visual timing markers in still another embodiment of the present invention.

### PREFERRED EMBODIMENT

To determine the physical characteristics of a weld performed by a given welding wire, especially a stick electrode, many specifications require production of a standard test assembly, such as set forth in a specific welding procedure specification (WPS). The standardized test assembly for subsequent physical analysis of a weld by a specific electrode is illustrated in FIG. 1 where test assembly A involves a joint of metal deposited in groove 10 between spaced metal plates 12, 14. The spaced plates define test groove 10 and have a thickness a generally between ½ and ¾ inch with a width b greater than 5 inches. Length c of test groove 10 is greater than ten inches and is preferably twelve inches. Actually the total length of the test groove used in the production of assembly A is greater than test length C, shown later as length L. In the preferred embodiment, tapered walls 20, 22 have an included angle e of about 20 degrees and are spaced from each other a distance d defining the bottom root gap of assembly A which gap is generally ½ inch to ⅝ inch and is filled by root bead 30 supported by backing 32 formed from steel, which will be adhered to the under side of assembly A.

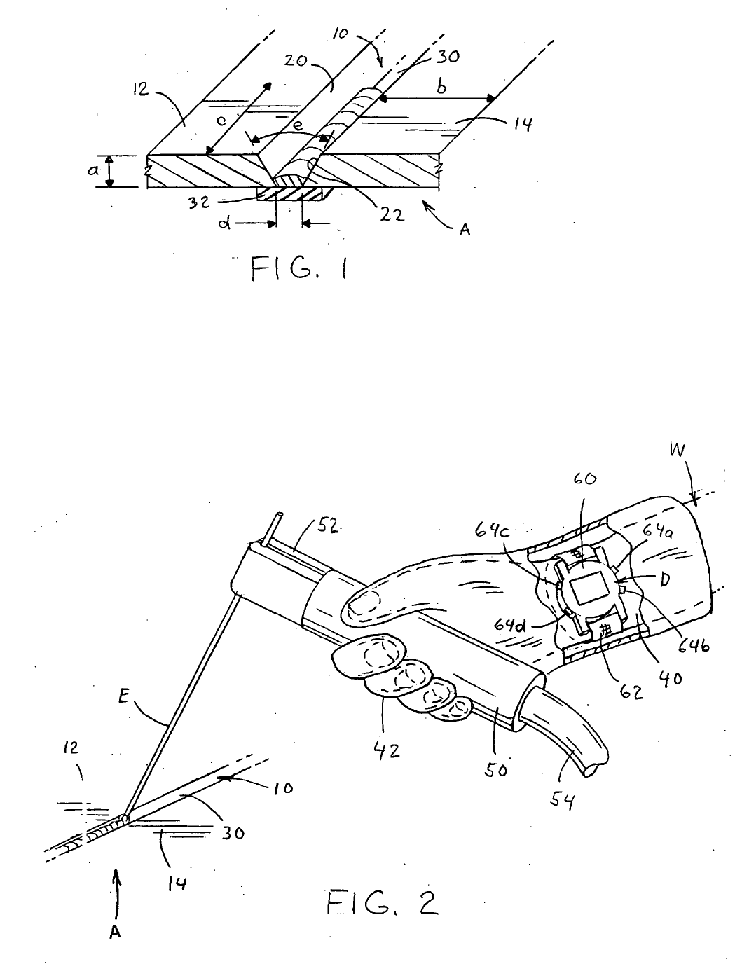

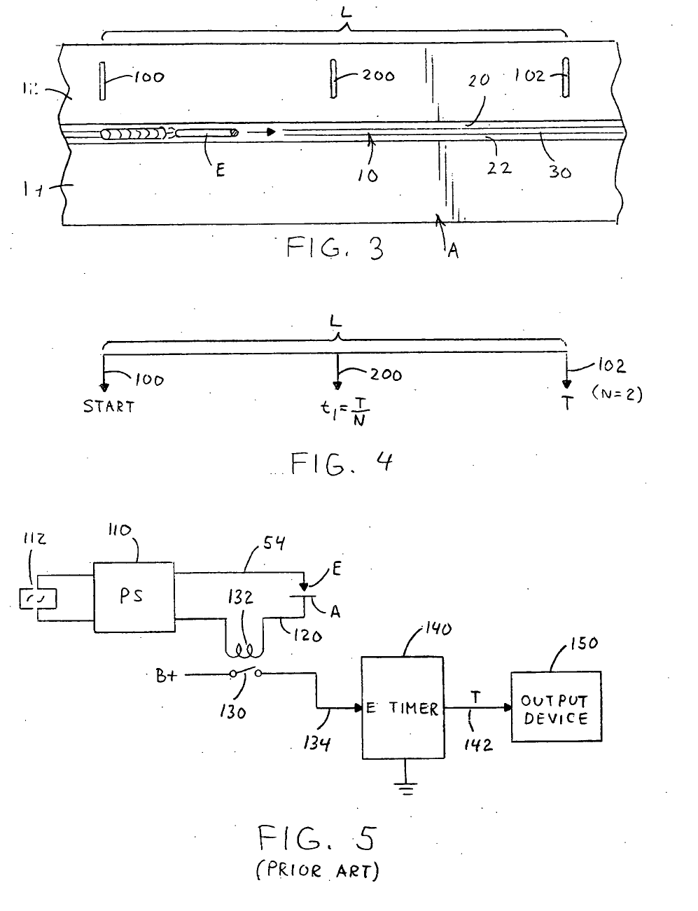

The present invention involves filling groove 10 with weld metal by a manual welding process performed by welder W, as schematically illustrated in FIG. 2. Welder W moves stick electrode E along groove 10 to fill the groove and finalize standardized test assembly A for subsequent physical testing. The resulting weld by electrode E determines the quality of the electrode. This quality is determined by analysis of assembly A after the assembly has been joined by a specified deposition process that is generally consistent along length L of test groove 10. This welding process is performed by manually moving electrode E, such as a cellulose stick electrode, along test groove 10 by welder W. Only the hand and wrist 40 of welder W is shown in FIG. 2. The hand of the welder is protected by glove 42 while electrode E is supported in holder 50 by alligator gripper 52 in accordance with standard stick welding practice. The electric arc welding is performed with a desired power determined by the current and voltage directed to electrode E by power lead 54. The welding process is performed by a specified setting of current and voltage to determine the power used in welding along groove 10 as electrode E is melted and deposited in the groove. In the past, this welding process was performed between two visual markers defining the test length L shown in FIG. 3. This test length is filled by melting electrode E using a set current and voltage. The time to weld length L determines the total energy during the welding process filling groove) 10. This total energy is divided by the inches constituting length L to determine the amount of Joules per inch used in the welding process along test length L. In the prior procedure, welder W starts the welding operation and proceeds until the test length L is reached. The time is recorded by a system shown in FIG. 5. To be acceptable the energy per inch of the welding groove 10 must be within the relevant specification. Only in this instance can the test assembly be employed for subsequent analysis of the weld to determine the quality of electrode E. The difficulty with prior procedures relates to the fact that welder W must be highly skilled to traverse length L in the desired time to conform with the specified input energy along groove 10. The present invention provides a method of pacing the welding process to assist the welder in traveling over length L in the desired time to have the specified heat input along groove 10. This novel method involves the use of haptic device D in the form of a tactile alarm 60 with a wrist band 62 supporting the tactile alarm onto wrist 40 of welder W. Set buttons 64a, 64b, 64c and 64d are used to set the alarm time of device D to perform the pacing method of the present invention. In practice, tactile alarm 60 is a MeDose vibrating alarm watch. The alarm watch has at least six different settings even though only one setting is used in practicing the preferred embodiment of the present invention. Device D is not used in accordance with the intended purpose of the product, but it is set to minutes for use in welding groove 10.

As described before, assembly A is formed by filling joint or groove 10 with a welding process using electrode E. To determine the start location of the welding process, a visual marker 100 is placed at a first location adjacent test groove 10 on assembly A. At the far end of length L, a second visual marker 102 is located. This second visual marker determines the end of the test welding process and is generally spaced twelve inches from marker 100. Welder W can visually determine marker 100 through the welding shield and commence the welding process at the start marker. This starting of the welding process activates the timing system shown in FIG. 5 where power source 110 is driven by supply 112 to produce a specified power across electrode E and test assembly A by power lead 54 and return power lead 120. To determine welding cycle time T, reed switch 130 is actuated by current flow through coil 132 to produce a start signal in line 134 to energize reset timer 140. At marker 102 welder W stops the welding process. This deactivates reed switch 130 so actual time T for the welding cycle appears in line 142 and is recorded or displayed by output device 150. As so far described, the showings in FIGS. 3-5 represent the prior method for forming standardized assembly A. Welder W starts the welding process at marker 100 and proceeds with the specified power being used by electrode E. At visual marker 102, the welding cycle is terminated and the total time T is recorded in output device 150. This time must be within certain narrower tolerances to provide a total heat input, usually specified as heat per inch along length L. To obtain this specification heat input value, the total heat used along length L is used to calculate the heat per inch. This value must be within the specified limits to accept assembly A for subsequent testing of quality of the weld performed by specific electrode E. To produce an acceptable test assembly requires skill. Rejects are not unusual since the welder can not see the time being consumed during the welding process. The welder can not watch a clock through the welding helmet or shield so the travel speed must be estimated and obtained by trial and error.

The present invention assists the welder in pacing the weld process. An added marker 200 is positioned along groove 10 as shown in FIG. 3. This added marker is at a known spacing from marker 100. In practice, this spacing is length L divided by 2. In FIG. 4 the spacing of added marker 200 is shown as it is equated to cycle the specified time T, as being T/N wherein N is 2. Thus, the desired cycle time T for obtaining the specified heat input is divided by 2 to provide time t₁. Time t₁ is set in haptic device D worn on wrist 40 of welder W as shown in FIG. 2. Thus, in accordance with the present invention, filling of groove 10 is commenced at marker 100 where reed switch 130 starts timer 140. At the same time, welder W actuates device D set to alarm at time t₁. When the welding process approaches marker 200, the alarm of device D is actuated. If the tactile alarm occurs before welder W is at added visual marker 200, the travel speed is thereafter increased. The amount of increase is based upon the amount of spacing between the alarm and reaching added marker 200. If the alarm occurs after marker 200, the travel speed of the welding process is decreased. This is again based upon the time between the alarm and reaching marker 200. In this manner, an adjustment of the travel speed is made at marker 200 to more easily pace the travel of electrode E along groove 10. In this manner, cycle time T is more easily within the desired tolerances of the specification for test assembly A.

In FIG. 6 the second embodiment of the present invention is illustrated wherein N is 3 so a first added visual marker 210 is ⅓ of the distance L. Time t₁ is ⅓ of the desired cycle time T. Device D is set to alarm at time t₁. A second visual marker 212 is ⅔ of the distance L and device D is set to expire at a second alarm time t₂ which second alarm time is ⅔ of the desired cycle time T. Thus, the welding process is paced at a first added visual marker 210 and a second added visual marker 212. Of course, the invention could involve further numbers of visual markers and further spaced tactile alarm times; however, a single marker as shown in FIGS. 3 and 4 is preferred. Two added markers as shown in FIG. 6 are probably the maximum number during the short welding cycle.

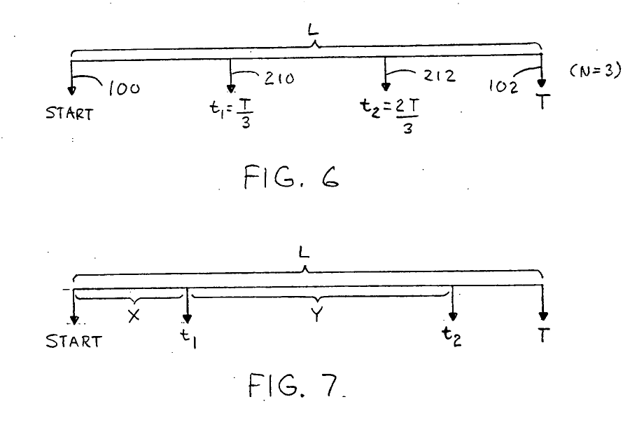

Regarding the invention, a single added marker is the first maker 200 or 210. Other markers are embodiments of the invention. Another aspect of the invention is schematically illustrated in FIG. 7 wherein length L includes two added visual markers at times t₁ and t₂. These markers are not equally spaced along length L; however, the distance x and y are coordinated with the time T so device D is set to cause a tactile alarm at time t₁ and t₂ each of which time are coordinated with an added marker adjacent groove 10. Other numbers and spacing of added visual markers are within the intended scope of the present invention. By using markers and the haptic device, preferably a tactile alarm, welder W can more precisely pace the travel speed of the welding operation along groove 10. Each embodiment includes a first added marker and an alarm at time t₁. The spacing and number of added markers with correlated alarm times are features of other embodiments within the intended scope of the invention.

1. A method of pacing a desired travel speed of a manual arc welding process performed by a welderfor depositing weld metal on a workpiece and along a test groove with a given test length defined by a visible start location and a visual end location using a specified amount of energy distributed generally uniformly in said groove between said locations, said method comprising:
(a) providing a power source with output leads and an arc current and an arc voltage;
(b) setting the output welding power of said power source;
(c) providing a consumable welding wire;
(d) connecting said output leads across said welding wire and said workpiece;
(e) determining the time T for said wire to traverse said test length to consume said specific amount of energy;
(f) marking said groove with a visible indicia spaced from said start location a given distance;
(g) associating a programmable haptic device with an exposed body part of said welder, said device having a tactile alarm activated after a programmed time t from start of said haptic device, which time t is coordinated with said given distance to give the desired travel speed;
(h) starting said haptic device when said operator commences welding at said start location and employs a manual rate of travel; and,
(i) changing said manual rate of travel according to the relationship of said wire to said indicia when said tactile alarm is activated.

2. A method as defined in claim 1 wherein said time t is generally T/N.

3. A method as defined in claim 2 wherein said indicia is a single marker halfway between said locations and N is 2.

4. A method as defined in claim 2 wherein said indicia is two equally spaced markers and N equals 3 with one of said markers provided in step (f) and the second marker spaced from said first market the general distance said first marker is spaced from said start location.

5. A method as defined in claim 1 wherein said haptic device is a device strapped onto the wrist of said welder.

6. A method as defined in claim 1 wherein said wire is a stick electrode.

7. A method as defined in claim 1 including:
(j) providing a cycle timer;
(k) starting said cycle timer when welding at said start location; and,
(l) stopping said cycle timer when the welder stops welding at said end location.

8. A method as defined in claim 7 including:
(m) recording the expired time of said cycle timer.

9. A method as defined in claim 1 wherein said specific amount of energy is 30-70 k Joules/in times said given test length.

10. A method as defined in claim 1 including:
(j) preheating said workpiece to 100-250° F.

11. A method of pacing the travel speed of a manual arc welding process performed by a welder for depositing weld metal on a workpiece and along a groove with a given test length defined by a visible start location and a visual end location using a specified amount of energy distributed generally uniformly between said locations, said method comprising:
(a) providing a power source with output leads and an arc current and an arc voltage;
(b) setting the output welding power of said power source;
(c) providing a consumable welding wire;
(d) connecting said output leads across said welding wire and said workpiece;
(e) marking said groove with one or more visual markers at a set distance or distances from said start location;
(f) associating a programmable haptic device with an exposed body part of said welder, said device having a tactile alarm activated at a programmed time or times after said device is started;
(g) starting said haptic device when said operator commences welding at said start location;
(h) comparing the spacing of said welding wire from one of said markers upon activation of said alarm; and,
(i) changing said manual rate of travel according to said spacing comparison.

12. A method as defined in claim 11 including increasing said rate an amount related to the spacing of said alarm before one of said markers.

13. A method as defined in claim 11 including decreasing said rate an amount related to the spacing of said alarm after one of said markers.

14. A method as defined in claim 13 wherein the method uses a single marker generally equidistance between said start location and said end location.

15. A method as defined in claim 11 wherein said haptic device is a device strapped onto the wrist of said welder.

16. A method as defined in claim 11 including:
(j) providing a cycle timer;
(k) starting said cycle timer when welding at said start location; and,
(l) stopping said cycle timer when stop welding at said end location.

17. A method as defined in claim 16 including:
(m) recording the expired time of said cycle timer.

18. A combination of elements for pacing the travel speed of an electrode used in producing a standardized test assembly by a manual arc welding process performed by a welder for depositing weld metal along a groove between two spaced plates, said groove having a given test length defined by a visible start location and a visual end location, said combination comprising: a visual marker adapted to be mounted beside said groove at a set distance from the start location of the groove; and a programmable haptic device adapted to be associated with an exposed body part of said welder, said device having a tactile alarm activated at a programmed time after the device is manually started by said welder where said programmed time is coordinated with said set distance.

19. A combination as defined in claim 18 wherein said haptic device is a device strapped onto the wrist of said welder.

20. A combination as defined in claim 18 including, as another component, a cycle timer, which timer has a first automatic input circuit to start said cycle timer when welding at said start location; and, a second automatic input circuit to stop said cycle timer when welding at said end location and a display to record the expired time of said cycle timer.
